(19) United States
(12) Patent Application Publication
(10) Pub. No.: US 2025/0380694 A1
(43) Pub. Date: Dec. 18, 2025

(54) THYMOL AND CITRIC ACID DISINFECTANT WITH IMPROVED EFFICIENCY

(71) Applicant: ROCKDALE RESEARCH AND IP HOLDINGS, LLC, Conyers, GA (US)

(72) Inventors: Phil GRIFFIN, Conyers, GA (US); Suhail MASSAD, Conyers, GA (US); Thomas O'LENICK, Conyers, GA (US)

(21) Appl. No.: 19/315,081

(22) Filed: Aug. 29, 2025

Related U.S. Application Data
(63) Continuation of application No. 19/197,334, filed on May 2, 2025.
Application No. 19/197,334 is a continuation of application No. PCT/US2024/038086, filed on Jul. 15, 2024.
(60) Provisional application No. 63/514,293, filed on Jul. 18, 2023.

(51) Int. Cl. A01N 37/36; A01N 25/04; A01N 31/08; A01P 1/00

(52) U.S. Cl. CPC A01N 37/36; A01N 25/04; A01N 31/08; A01P 1/00

(57) ABSTRACT

The present invention relates to a composition suitable for disinfecting surfaces which comprises contacting said formulation to an environmental surface wherein the formulation comprises thymol at a concentration ranging from at least 0.10% by weight and citric acid at a concentration from at least 0.3% by weight. Surprisingly and unexpectantly these concentrations provide formulations that are more effective in disinfecting than ones containing less of the two materials, or significantly more citric acid, or having ju

### CROSS-REFERENCE TO RELATED APPLICATIONS

This application is a continuation application of U.S. application Ser. No. 19/197,334, filed May 2, 2025, entitled “THYMOL AND CITRIC ACID DISINFECTANT WITH IMPROVED EFFICIENCY”, which is a continuation application of international application no. PCT/US2024/038086 file Jul. 15, 2024, entitled “THYMOL AND CITRIC ACID DISINFECTANT WITH IMPROVED EFFICIENCY,” which claims the benefit of priority of U.S. Provisional Application No. 63/514,293 filed Jul. 18, 2023, entitled “THYMOL AND CITRIC ACID DISINFECTANT WITH IMPROVED EFFICIENCY,” which are all incorporated herein by reference their entirety.

### BACKGROUND OF THE INVENTION

In spite of modern improvements in hygiene and infection prevention, the ability to selectively control infections, and disinfection represents a long-felt need. SARS and COVID are two specific examples.

Pathogens such as bacteria, fungi, viruses, and bacterial spores are responsible for a plethora of human and animal ills, as well as contamination of food and biological and environmental samples. The first step in microbial infections of animals is generally attachment or colonization of skin or mucus membranes, followed by subsequent invasion and dissemination of the infectious microbe. The portals of entry of pathogenic bacteria and viruses are predominantly the skin and mucus membranes.

Virtually every intensive livestock producer accepts that effective disease prevention is key for maintaining a healthy enterprise. Over the years the improvement in and availability of vaccines has greatly assisted in the prevention of a large number of diseases. However, even a well vaccinated live-stock can succumb under severe challenge. Moreover, since vaccines are not available for all the diseases to be prevented, producers have accepted that a well-planned and monitored bio-security program, coupled with an effective disinfection and vaccination program, is essential for maintaining the health of their stock.

Avian influenza is an infectious disease of birds caused by type A strains of the influenza virus. The disease, which was first identified in Italy more than 100 years ago, occurs world-wide. All birds are thought to be susceptible to infection with avian influenza, though some species are more resistant to infection than others. Domestic poultry, including chickens and turkeys are particularly susceptible to epidemics of rapidly fatal influenza.

Fifteen subtypes of influenza virus are known to infect birds, thus providing an extensive reservoir of influenza viruses potentially circulating in bird populations. To date, all outbreaks of the highly pathogenic form have been caused by influenza A viruses of subtypes HS and H7. Recent research has shown that viruses of low pathogenicity can, after circulating for sometimes short periods in a poultry population, mutate into highly pathogenic viruses.

The quarantining of infected farms and destruction of infected or potentially exposed flocks are standard control measures aimed at preventing spread to other farms and eventual establishment of the virus in a country's poultry population. Apart from being highly contagious, avian influenza viruses are readily transmitted from farm to farm by mechanical means, such as by contaminated equipment, vehicles, feed, cages, or clothing. Stringent sanitary measures on farms can, however, confer some degree of protection.

A great many of the current antimicrobial compositions, including sanitizers and disinfectants, contain antimicrobial agents which are not naturally occurring. Typical antimicrobial agents used in sanitizers and disinfectants include chemical disinfectants such as phenolic compounds, quaternary ammonium compounds, formaldehyde and halogen containing compounds. Such materials are not of natural origin (i.e. not found in nature) and are prepared through chemical processing and synthesis. A great many of these “synthetic” disinfectants cause undesirable effects on both the environment and on human health. The concept of formulating disinfectants, essentially involving the selection of a simple chemical disinfectant and enhancing its activity by adding other chemicals, evolved in the seventies. U.S. Pat. No. 9,451,763 to Daigle, incorporated herein by reference, filed in May 2014, teaches the state of the art for disinfectants.

The enhancement of the activity of a simple chemical disinfectant or combination of simple disinfectants to increase the spectrum of activity frequently involves the addition of additional chemical agents. Such additional chemical agents will generally have an effect on the pH and surface activity of the formulated product once in solution. It is well established that a number of simple disinfectants demonstrate their optimum activity at a specific pH (i.e. acidity or alkalinity). The ability of the disinfectant solution to make complete and even contact with the surface to be treated is also of great importance. This can generally be achieved by the addition of a surfactant or detergent to the formulation.

Disinfectants play a vital role in any biosecurity system, both in the process of terminal disinfection and in the ongoing hygiene maintenance. Apart from relatively minor changes and improvements in formulations, there has been little innovation in livestock disinfectant and large surface disinfectant development for some fifteen to twenty years.

While some natural plant oils have been known since antiquity to have curative properties, the topical and oral benefits of natural plant oils have more recently been attributed to anti-microbial properties. A great many of the natural essential oils are derived from cajeput, cedarwood, citronella, clove, cypress, fir needle, eucalyptus, garlic, lavender, lemon, lemongrass, marjoram, niaouli, onion, orange, oregano, patchouli, peppermint, rosemary, rosewood, tea tree, thyme oil, y-lang and vetiver. Of these natural essential oils, oregano oil, comprising a complex mixture of anti-microbial compounds, has been used as a reference for the comparison of the bactericidal action of other substances owing to its near ideal antibacterial properties. Oregano oil has been shown to exert a high degree of anti-fungal, anti-parasitic, antiviral and anti-bacterial action. The phenolic flavonoids carvacrol and thymol are two potent natural antiseptic agents encountered primarily in oregano oil and thyme oil.

Attempts have been made to formulate disinfectant solutions based upon essential oils. However, because of their hydrophobic nature, essential oils are not readily miscible in water. As a result, essential oils are often difficult to prepare in a form that will allow them to be readily incorporated into an aqueous solution.

U.S. Pat. No. 5,403,587 issued to McCue et al. on Apr. 4, 1995, discloses an antimicrobial composition that uses both a solvent and a surfactant to facilitate the formation of a homogeneous aqueous mixture of an essential oil. However, this composition is not suitable for disinfecting large surfaces such as commonly encountered in agricultural settings where the disinfectant solution is commonly prepared from a concentrate using the onsite water source.

The present invention refers to a number of documents, the contents of all of which are herein incorporated by reference in their entirety.

### SUMMARY OF THE INVENTION

The present invention relates to microemulsion with disinfectant properties comprising of thymol and citric acid.

The disinfectant formulations in embodiments of the present invention further comprise a surfactant. A surfactant operative herein comprises a water soluble or water dispersible nonionic, anionic, cationic or an amphoteric compound. Non-limiting examples of surfactants include sodium lauryl sulfate, sorbitan stearate, sorbitan esters, sodium laureth sulfate, sarkosyl, cocamidopropyl betaine, sodium lauryl ether sulfonate, alkyl benzene sulfonates, and ether ethoxylate.

The present invention relates to a microemulsion suitable for disinfecting surfaces which comprises contacting said formulation to an environmental surface wherein the formulation comprises thymol at a concentration from about 0.10% to about 1% by weight, including one embodiment of at least from about 0.18% by weight to about 1% by weight, and citric acid from at least about 0.30% to about 3% by weight, including one embodiment of at least about 0.40% to about 3% by weight. Surprisingly and unexpectantly these concentrations provide formulations that are more effective in disinfecting. Formulations with concentrations lower than the specified ranges simply are not effective when applied to specific microbes, resulting in poor performance as a wide range antimicrobial.

### DETAILED DESCRIPTION

The ability to control microbes on environmental surfaces is a major goal for environmental disinfectants. This ability not only applies to the concentration of microbes present on an environmental surface but also the type of microbe. In addition, the disinfectant applied to a surface must have selective toxicity, effective against microbes and minimally toxic to people that come into contact with the environmental surface. The concept of selective toxicity on disinfectants is critical. The present invention is based upon a surprising and unexpected discovery that by controlling the concentration of citric acid and thymol to specific concentrations in a formulation the effectiveness of the disinfectant is improved significantly.

Microbes include bacteria, which are divided into gram negative and gram positive type, viruses (especially those that are disease communicable like SARS and COVID), and fungi.

In an embodiment, the present invention relates to an aqueous disinfectant formulation comprising aqueous solutions of thymol and citric acid as set forth in the following Formulation

### EXAMPLES

### Formulation Examples

| | TSP-070 | TSP-080 | TSP-050 | TSP-060 | TSP-090 | TSP-020 | TSP-100 | TSP-010 |
|---|---|---|---|---|---|---|---|---|
| Thymol | 0.00 | 0.18 | 0.18 | 0.23 | 0.23 | 0.23 | 0.35 | 0.35 |
| Citric Acid | 0.60 | 0.40 | 0.60 | 0.00 | 0.40 | 0.60 | 0.40 | 0.60 |
| Surfactant | 0.46 | 0.40 | 0.40 | 0.46 | 0.46 | 0.46 | 0.70 | 0.70 |
| Water | 98.94 | 99.02 | 98.24 | 99.31 | 98.91 | 98.71 | 98.55 | 98.35 |
| | 100.00 | 100.00 | 100.00 | 100.00 | 100.00 | 100.00 | 100.00 | 100.00 |

Disinfectant testing results for several of the Formulation Examples with respect to the listed bacteria and viruses include:

| | | | | | TSP- | TSP- | | | TSP- |
|---|---|---|---|---|---|---|---|---|---|
| | | | | | 020 | 050 | | | 080 |
| | | | | | (.23% | (.18% | | TSP- | (.18% |
| | | | | | Thymol | Thymol | TSP- | 070 | Thymol |
| | | | | | & .6% | & .6% | 060 | (.6% | & .4% |
| | Thymol | Citric Acid | | Testing | Citric | Citric | (.23% | Citric | Citric |
| Pathogen | Disinfectant | Disinfectant | | Time | Acid) | Acid) | Thymol) | Acid) | Acid) |
| Bacteria | | | | | | | | | |
| Staphylococcus | 2 Min | 5 | Min | 2 Min | 0/60 | 0/60 | 1/10 | 0/10 | 0/10 |
| aureus | | | | | | | | | |
| Vancomycin-Resistant | Not | Not | | 2 Min | 0/10 | Not | Not | Not | Not |
| Staphylococcus | Reported | Reported | | | | Tested | Tested | Tested | Tested |
| aureus | | | | | | | | | |
| Methicillin Resistant | Not | Removed | | 2 Min | 0/10 | 0/10 | Not | Not | Not |
| S. Epidermis (MRSE) | Reported | | | | | | Tested | Tested | Tested |
| Penicillin resistant | Not | Not | | 2 Min | 0/10 | 0/10 | Not | Not | Not |
| Staphylococcus (PR) | Reported | Reported | | | | | Tested | Tested | Tested |
| Viruses: | | | | | | | | | |
| Feline Calicivirus | 4 Min | 10 | Min | 2 Min | ≥4.61 | ≥4.61 | 2.30 | ≥5.10 | ≥5.10 |
| | | | | | Log | Log | log | Log | Log |
| Adenovirus Type 2 | Not | 5 | Min | 1 Min | ≥5.74 | ≥5.74 | Not | Not | Not |
| | Reported | | | | Log | Log | Tested | Tested | Tested |
| Poliovirus Type 1 | Not | 10 | Min | 1 Min | ≥6.26 | 5.45 | Not | Not | Not |
| | Reported | | | | Log | Log | Tested | Tested | Tested |
| Canine Parovirus | Not | 5 | Min | 2 Min | 3.08 | 3.0 | Not | Not | Not |

| | | | | | | | | |
|---|---|---|---|---|---|---|---|---|
| (CPV) | Reported | | | Log | Log | Tested | Tested | Tested |
| Influenza virus B | Not | Not | 1 Min | ≥4.43 | ≥4.43 | Not | Not | Not |
| | Reported | Reported | | Log | Log | Tested | Tested | Tested |

In an exemplary test the TSP-010; TSP-020; TSP-030; TSP-040; TSP-050 and formulations were also tested for disinfection efficacy as to the test microorganism (bacteria) Salmonella enterica ATCC 10708, and the efficacy results were:

Efficacy Result for TSP-010: Following a 2-minute contact time, 0 of 60 carriers demonstrated turbidity and were positive for growth.

Efficacy Result for TSP-020: Following a 2-minute contact time, 0 of 60 carriers demonstrated turbidity and were positive for growth.

Efficacy Result for TSP-030: Following a 2-minute contact time, 0 of 60 carriers demonstrated turbidity and were positive for growth.

Efficacy Result for TSP-040: Following a 2-minute contact time, 1 of 60 carriers demonstrated turbidity and were positive for growth.

Efficacy Result for TSP-050: Following a 2-minute contact time, 0 of 60 carriers demonstrated turbidity and were positive for growth.

In embodiments of the invention, the citric acid concentration was determined by studying Staphylococcus aureus and Feline Calicivirus. The examples were tested for the virucidal efficiency against Feline calicivirus (EPA-approved human norovirus surrogate), F-9 strain, ATCC VR-782 supplemented with 5% FBS soil load, at a contact time of 2 minutes and exposure temperature of ambient room temperature. Example TSP-060, containing 0.00% wt/wt citric acid demonstrated an average of 2.30 log₁₀ reduction. All of the other examples (TSP-070, TSP-080, TSP-050, TSP-060, TSP-020, TSP-010) contained citric acid and achieved a higher log reduction, with TSP-080 containing the least amount of actives (Thymol 0.18% wt/wt and 0.40% wt/wt citric acid) still achieving≥5.10 log₁₀ reduction.

Hepatitis A Virus and Canine Parvovirus (CPV) were also used to evaluate the amount of thymol needed in the current invention. Two examples were selected, TSP-020 and TSP-050. TSP-050 containing 0.18% wt/wt thymol and 0.60% wt/wt citric acid and TSP-020 containing 0.23% wt/wt thymol and 0.60% wt/wt citric acid. TSP-050 demonstrated a 0.85 log₁₀ reduction and a 3.00 log₁₀ reduction when tested against Hepatitis A and CPV respectively. The results suggest that the thymol concentration should be kept above about 0.10% wt/wt, and preferably above about 0.18% wt/wt. In some embodiments, thymol concentrations of the invention are in the range of from about 0.10% wt/wt to about 1% wt/wt, and preferably from 0.18% wt/wt to about 1% wt/wt.

Additional Tests for Virus Disinfection Efficacy included:

Feline Calicivirus (Report: NG 20445)

| Test | Contact Time | Log₁₀ | % |
|---|---|---|---|
| TSP-010 | 2 min | ≥4.61 | ≥99.997 |
| TSP-020 | 2 min | ≥4.61 | ≥99.997 |
| TSP-030 | 2 min | 3.61 | 99.97 |
| TSP-040 | 2 min | 3.61 | 99.97 |
| TSP-050 | 2 min | ≥4.61 | ≥99.997 |

Human Coronavirus (Report: NG 20330)

| Test | Contact Time | Log₁₀ | % |
|---|---|---|---|
| TSP-010 | 1 min | ≥3.62 | ≥99.997 |
| TSP-020 | 1 min | ≥4.80 Log | 99.97 |
| TSP-030 | 1 min | 4.29 | 99.99 |
| TSP-040 | 1 min | 4.19 | 99.99 |
| TSP-050 | 1 min | ≥4.80 Log | ≥99.999 |

Influenza, Herpes Simplex Types 1 and 2 and Adenovirus Type 2:

| | | Testing | | | |
|---|---|---|---|---|---|
| | | Time | TSP - | TSP - | |
| Pathogen | Ref # | Submitted | 020 | 050 | |
| Influenza A | ATCC | 1 Min | ≥4.18 | ≥4.18 | Current |
| (H1N1) virus | VR-333 | | Log | Log | |
| Herpes Simplex | ATCC | 1 Min | ≥4.24 | ≥4.24 | New |
| Type 2 | VR-734 | | Log | Log | |
| (strain G) | | | | | |
| Herpes Simplex | ATCC | 1 Min | ≥6.18 | ≥6.18 | New |
| Type 1 | VR-733 | | Log | Log | |
| Adenovirus | ATCC | 1 Min | ≥5.74 | ≥5.74 | New |
| Type 2 | VR-5 | | Log | Log | |

Preparation of Preferred Disinfectant Formulation Comprising Citric Acid and Thymol

A particularly advantageous composition (“Working Formula”) has been determined as follows:

| Ingredients | % by weight |
|---|---|
| Thymol Crystals | 0.23 |
| SLS-30 sodium lauryl sulfate provided as 30% active) | 1.53 |
| Citric Acid | 0.6 |
| Water | 97.64 |

When sodium lauryl sulfate (SLS) is expressed as 100% active, the Working Formula is as follows:

| Ingredients | % by weight |
|---|---|
| Thymol Crystals | 0.23 |
| SLS-100 (sodium lauryl sulfate provided as 100% active) | 0.46 |
| Citric Acid | 0.6 |
| Water | 98.71 |

An exemplary preparation method for an aqueous solution having the Working Formula includes mixing the amount of thymol, SLS and between 2.5%-5% of the required water as a pre-mixture and then heating that pre-mixture to 130° F. and mixing for 15-30 minutes until the solution of pre-mixture turns clear. Slowly and while mixing, the remaining quantity of the water and citric acid is added to the clear solution of pre-mixture and the entire disinfectant solution is mixed for an additional approximately 15 minutes until all ingredients are dissolved. It was discovered that if the pre-mixture is not prepared including thymol, the thymol does not properly dissolve as part of the entire disinfectant solution.

Although other cleaning compositions including thymol and citric acid have been disclosed, such as in U.S. Pat. Nos. 7,851,430 and 7,642,227 and related product Melaleuca Sol-U-Guard™ 2X Concentrate. However, these other compositions do not exhibit the improved efficacy of the “Working Formula” and similar formulations of the invention that, for example, do not include the significantly heightened levels of citric acid that the present invention does not use. For example, Melaleuca Sol-U-Guard™ 2X Concentrate includes 4% citric acid and.092% thymol. Even assuming dilution of the Melaleuca Sol-U-Guard™ 2X Concentrate, the Working Formula of the present invention includes almost 3.5 to 7 times less citric acid and about 5 to 2.5 times more thymol. In this regard, the weight ratios of citric acid:thymol are about 43.5:1 for Sol-U-Guard and about 3:1 for the Working Formula. It has been discovered that the advantages of the present invention formulation with lower citric acid content provide less expensive manufacturing costs, less corrosive formulations, desirable clarity, and no unwanted residue when the disinfectant is used on surfaces. Further, a comparison of efficacy (based on available contact times of respective Working Formula solution and Melaleuca Sol-U-Guard™ 2X Concentrate) against various pathogens, suggests that the inventive formulations also exhibit more favorable efficacy for many pathogens.

Specifically, the following table shows an efficacy comparison of the “Working Formula” of the invention vs. Melaleuca Sol-U-Guard™ 2X Concentrate as follows:

| | | Melaleuca |
|---|---|---|
| | | Sol-U- |
| | “Working | Guard 2X |
| Pathogen | Formula” | Concentrate |
| | Contact | |
| | Time | |
| Bacteria | (mins) | |
| Staphylococcus aureus | 2 Min | 1 Min |
| Salmonella enterica | 2 Min | 10 Min |
| Pseudomonas aeruginosa | 2 Min | 10 min |
| Methicillin Resistant S. aureus (MRSA) | 2 Min | 10 Min |
| Vancomycin-Resistant Enterococcus Faecalis | 2 Min | Not Listed |
| (VRE) | | |
| Methicillin Resistant S. Epidermis (MRSE) | 2 Min | Not Listed |
| Klebsiella Aerogenes - Enterobactor aerogenes | 2 Min | 30 sec |
| Escherichia coli | 2 Min | 1 Min |
| Acinetobacter Baumannii - Nosocomial | 2 Min | Not Listed |
| infection (hospital) | | |
| Klebsiella Pneumoniae NDM-1 Resistant | 2 Min | Not Listed |
| Listeria Monocytogenes (Listeria) | 2 Min | Not Listed |
| Streptococcus Suis | 2 Min | 10 Min |
| Penicillin resistant Staphylococcus (PR) | 2 Min | Not Listed |
| Vancomycin-Resistant Staphylococcus aureus | 2 Min | Not Listed |
| Mycobacterium Bovis (TB) | 2 Min | Not Listed |
| Totals ML's Needed for Testing | | |
| Fungi: | | |
| Trichophyton interdigitale | 3 min | Not Listed |
| Candida albicans | 3 min | Not Listed |
| Stachybotrys chartarum | 3 min | Not Listed |
| Penicillium Aspergillus | 3 min | Not Listed |
| Candidas auris - Emergin pathogen (CDC), | 3 min | Not Listed |
| nosocomial infection | | |
| Totals ML's Needed for Testing | | |
| Viruses: | | |
| Norovirus - (Surogate Feline Calicivirus) | | |
| Feline Calicivirus | 2 min | Not Listed |
| Human Coronavirus | 1 min | Not Listed |
| Rhinovirus | 1 min | 10 Min |
| Rotavirus (Most common diarrhea-causing | 1 min | 10 Min |
| virus in children/76 nm) | | |
| Influenza A (H1N1) virus | 1 min | 10 Min |
| Vaccinia Virus | 1 min | Not Listed |
| Respiratory Syncytial Virus (RSV) | 1 min | Not Listed |
| Herpes Simplex Type 1 | 1 min | Not Listed |
| Herpes Simplex Type 2 (strain G) | 1 min | Not Listed |
| Adenovirus Type 2 | 1 min | Not Listed |
| Poliovirus Type 1 | 1 min | 10 Min |
| Canine Parvovirus (CPV) | 2 min | Not Listed |
| Influenza A Avian (H3N2) virus | 1 min | 1 Min |
| Influenza virus B | 1 min | Not Listed |
| PEDv (Porcine epidemic diarrhea virus) | 1 min | Not Listed |
| Colorado 2013 Isolate Strain | | |

Various embodiments of the invention have been described. It will, however, be evident that various modifications and changes may be made thereto, and additional embodiments may be implemented, without departing from the broader scope of the invention as set forth by the disclosure. This specification is to be regarded in an illustrative rather than a restrictive sense.

What is claimed is:

1. An aqueous disinfectant composition comprising:
thymol from at least about 0.10% to about 1.0% by weight;
surfactant from at least about 0.40% by weight to sufficient to form a solution of dissolved thymol in water;
from at least about 0.30% to about 3% by weight citric acid; and
water to make a 100% weight solution that is substantially free of other solvents.

2. The composition of claim 1, wherein the by weight percent ratio of citric acid to thymol is from 1:1 to 10:1.

3. The composition of claim 2, wherein the by weight percent ratio of citric acid to thymol is from 2:1 to 5:1.

4. The composition of claim 2, wherein the by weight percent ratio of citric acid to thymol is from 3:1 to 4:1.

5. The composition of claim 1, further comprising at least about 0.18% thymol by weight.

6. The composition of claim 5, further comprising at least about .40% citric acid by weight.

7. The composition of claim 1, further comprising at least about .40% citric acid by weight.

8. The composition of claim 1, further comprising a microemulsion.

9. An aqueous disinfectant composition comprising:
from about 0.18% to about 0.25% by weight thymol;
from about 0.30% to about 0.50% by weight surfactant, wherein the amount of surfactant is sufficient to form a solution of dissolved thymol in water;
from about 0.30% to about 0.80% by weight citric acid; and
water to make a 100% weight solution that is substantially free of other solvents.

10. The composition of claim 8, further comprising:
about .23% by weight thymol;
about .6% by weight citric acid;
about .46% by weight sodium lauryl sulfate as 100% active; and
about 98.71% by weight water.

11. The composition of claim 10, further comprising a microemulsion.

12. The composition of claim 9, further comprising a microemulsion.

13. An aqueous disinfectant composition comprising:
thymol from at least about 0.10% by weight;
surfactant from at least about 0.30% by weight;
from at least about 0.30% by weight citric acid to about 3% by weight citric acid; and
water to make a 100% weight solution that is substantially free of other solvents.

14. The composition of claim 13, further comprising at least about .18% by weight thymol.

15. The composition of claim 14, further comprising at least about .40% by weight citric acid.

16. The composition of claim 13, further comprising at least about .40% by weight citric acid.

17. The composition of claim 13, further comprising a microemulsion.

18. An aqueous disinfectant composition comprising:
thymol from at least about 0.10% to about 1% by weight;
surfactant from at least about 0.30% by weight;
citric acid from at least about 0.30% by weight; and
water to make a 100% weight solution that is substantially free of other solvents.

19. The composition of claim 18, further comprising at least about 0.40% citric acid.

20. The composition of claim 19, further comprising at least about 0.18% thymol.

21. The composition of claim 18, further comprising at least about 0.18% thymol.

22. The composition of claim 18, further comprising a microemulsion.
